(19) United States
(12) Patent Application Publication
(10) Pub. No.: US 2008/0257057 A1
(43) Pub. Date: Oct. 23, 2008

(54) Device for fatigue testing an implantable medical device

(76) Inventors: Jason A. Habeger, Belleville, MI (US); Benny M. Hillberry, Sun City Center, FL (US); Eric A. Nauman, West Lafayette, IN (US); Wendy A. Kerr, Cincinnati, OH (US); Megan M. Mauck, Boonville, IN (US); Rita J. Michlitsch, Grand Haven, MI (US); Haroun Soud Al-Mishwit, Brookfield, WI (US); Andrew D. Schwinke, Vernon Hills, IL (US); John G. Nolfi, Lafayette, IN (US)

Correspondence Address: BRINKS HOFER GILSON & LIONE, P.O. BOX 10395, CHICAGO, IL, 60610, US

(21) Appl. No.: 11/906,281

(22) Filed: Oct. 1, 2007

Related U.S. Application Data
(60) Provisional application No. 60/848,500, filed on Sep. 29, 2006.
(60) Provisional application No. 60/850,999, filed on Oct. 10, 2006.

(51) Int. Cl. G01N 3/32

(52) U.S. Cl. 73/808

(57) ABSTRACT

A device for fatigue testing an implantable medical device having a compression assembly and a first bending assembly. The compression assembly supports first and second portions of the implantable medical device so as to apply a compression force to the implantable medical device along a compression axis and at a compression angle. The first bending assembly is configured to apply a first bending force onto the implantable medical device to move the first portion of the implantable medical device about a first bending axis with respect to the second portion of the implantable medical device. The first bending assembly is coupled with the compression assembly such that the compression angle remains substantially constant regardless of the position of the first portion of the implantable medical device with respect to the second portion of the implantable medical device.

### CROSS-REFERENCE TO RELATED APPLICATIONS

This patent application claims the benefit under 35 U.S.C. § 119(e) of U.S. provisional patent application Ser. No. 60/848,500, filed Sep. 29, 2006 and provisional patent application Ser. No. 60/850,999, filed Oct. 10, 2006, each of which is hereby incorporated by reference.

### 1. FIELD OF THE INVENTION

The invention relates generally to a device for testing an implantable medical device. More specifically, the invention relates to a device for testing functional and wear characteristics of an implantable medical device, such as a spinal implant.

### 2. RELATED TECHNOLOGY

During the developmental stages of an implantable medical device, it may be desirable to test various aspects of a prototypical device before the device is implanted into patients. Additionally, during production stages of an implantable medical device, it may be desirable to test all or a sample set of the devices before being implanted into patients. For example, it may be desirable to test functional characteristics of the device, such as mobility, range of movement, or load capacity. As another example, it may be desirable to test the fatigue characteristics of the device, such as part wear or failure conditions.

It is desirable to test the implantable medical device under conditions that accurately and precisely simulate the conditions within the patient's body during actual use. For example, during typical use in a patient's body, a spinal implant may experience compression loads (such as when the patient is standing and/or carrying a heavy object) as well as relative movement along any or all of the following axes: an X-axis axis (such as when the patient is bending forward); a Y-axis axis (such as when the patient is bending side-to-side); or a Z-axis (such as when the patient is twisting his/her upper body). Therefore, it is desirable to provide a testing device for testing implantable medical devices that is able to facilitate three-dimensional movement of the implantable medical device while applying compression load thereon.

However, current testing devices are often unable to apply consistent compressive loads throughout the above-described relative movements about the X-axis, the Y-axis, and the Z-axis. For example, current testing devices typically include linear force applicators that independently apply forces along different axes to simulate different types of loads. More specifically, current testing devices include: a first set of opposing force applicators extending along the Z-axis and acting on the top and bottom of the implantable medical device to simulate axially-compressive loads on the implantable medical device; a second set of opposing force applicators extending along the Y-axis and acting on the front and back of the implantable medical device to simulate forward or backward bending movements of the implantable medical device; and a third set of opposing force applicators extending along the X-axis and acting on the sides of the implantable medical device and simulate side-to-side bending movement of the implantable medical device. However, this type of testing device may create inconsistent compressive loads acting on the implantable medical device. For example, when either of the second or third sets of force applicators are actuated, the angular position between the upper and lower portions of the implantable medical device is altered, thereby altering the effective axial compressive load acting on the implantable medical device.

Additionally, current testing devices typically include hydraulic actuators for applying the above-described linear forces. However, it is difficult to maintain the calibration of hydraulic actuators over an extended period of time, thereby potentially causing inconsistent loads acting on the implantable medical device and potentially causing inaccurate testing results. For example, hydraulic fluid may escape the actuators over the life of a testing cycle (upwards of tens of millions of repetitions).

Therefore, it is desirable to provide a device for testing an implantable medical device that is able to apply consistent and controllable loads on the medical device throughout the life of a testing cycle.

### SUMMARY

In one aspect of the present invention, a device for fatigue testing an implantable medical device is provided, having a compression assembly for supporting first and second portions of the implantable medical device and for applying a compression force to the implantable medical device along a compression axis at a compression angle with respect to the first portion of the implantable medical device; and a first bending assembly for applying a first bending force onto the implantable medical device to move the first portion of the implantable medical device about a first bending axis with respect to the second portion of the implantable medical device. The first bending assembly is coupled with the compression assembly such that the compression angle remains substantially constant regardless of the position of the first portion of the implantable medical device with respect to the second portion of the implantable medical device.

In one embodiment, the first portion of the implantable medical device defines a longitudinal axis and the compression axis remains substantially parallel to the longitudinal axis throughout testing of the implantable medical device.

In another embodiment, the compression assembly includes a first clamp and a second clamp, and the first bending assembly includes a support bar configured to support the first clamp and to pivot about the first bending axis with respect to the second clamp. The support bar is preferably a U-shaped bar.

In yet another embodiment, the first clamp of the compression assembly is configured to move in unison with the first portion of the implantable medical device about the first bending axis.

In another embodiment, the device includes a second bending assembly configured to apply a second bending force onto the implantable medical device to move the first portion of the implantable medical device about a second bending axis with respect to the second portion of the implantable medical device. The second bending assembly is coupled with the compression assembly such that the compression angle remains substantially constant regardless of the position of the first portion of the implantable medical device with respect to the second portion of the implantable medical device. The first clamp of the compression assembly is preferably configured to move in unison with the second portion of the implantable medical device about the second bending axis.

In yet another embodiment, the device further includes a rotational assembly configured to apply a rotational force onto the implantable medical device to move the first portion of the implantable medical device about the compression axis with respect to the second portion of the implantable medical device.

In another embodiment, the device further includes first, second, and third actuators for applying onto the implantable medical device the first, second, and rotational forces, respectively.

In another aspect of the present invention, a device for fatigue test an implantable medical device is provided, including: a compression assembly for supporting first and second portions of the implantable medical device and applying a compression force to the implantable medical device along a compression axis; a flexion assembly for applying a flexion force onto the implantable medical device to move the first portion of the implantable medical device about a flexion axis with respect to the second portion of the implantable medical device; a lateral bending assembly for applying a lateral bending force onto the implantable medical device to move the first portion of the implantable medical device about a lateral bending axis with respect to the second portion of the implantable medical device; and an axial rotation assembly for applying a rotational force onto the implantable medical device to move the first portion of the implantable medical device about the compression axis with respect to the second portion of the implantable medical device. The flexion assembly and the lateral bending assembly are coupled with each other such that the first portion of the implantable medical device is able to move simultaneously about the flexion axis and the lateral bending axis.

In yet another aspect, a device for fatigue testing an implantable medical device is provided, including: a compression assembly for applying a compression force to the implantable medical device along a compression axis; a flexion assembly for applying a flexion force onto the implantable medical device about a flexion axis; a lateral bending assembly for applying a lateral bending force onto the implantable medical device about a lateral bending axis; and an axial rotation assembly for applying a rotational force onto the implantable medical device about the compression axis. The flexion assembly, the lateral bending assembly, and the axial rotation assembly are coupled with each other such that they are able to apply the flexion force, the lateral bending force, and the rotational force simultaneously or individually.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is an isometric view of a device for fatigue testing an implantable medical device embodying the principles of the present invention; and

FIG. 2 is a side view of the testing device shown in FIG. 1; and

FIG. 3 is an exemplary implantable medical device suitable for testing in a testing device embodying the principles of the present invention.

### DETAILED DESCRIPTION

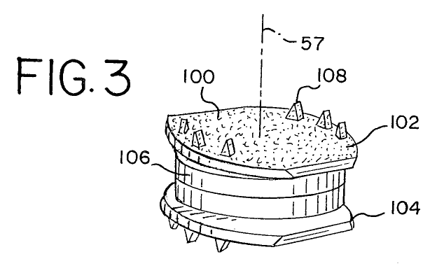

Referring now to the drawings, FIG. 3 shows an exemplary implantable medical device 100 that is suitable for testing in a testing device embodying the principles of the present invention. The implantable medical device 100 includes an upper portion 102 and a lower portion 104 that engage each other such as to permit slight, three-dimensional movement therebetween. The implantable medical device 100 is a Charite Artificial Disc manufactured by Johnson & Johnson and intended for use as a lumbar disc replacement. The implantable medical device 100 is an unconstrained three-component design made from two metal endplates with an interposed polyethylene-sliding core 106. It also contains six fixation teeth 108 on both endplates to maintain its placement within the vertebral body. Bio-active coating is available outside the United States to help promote bony in-growth.

Although a Charite Artificial Disc is shown in FIG. 3, any other suitable implantable medical devices may be tested in a testing device embodying the principles of the present invention, such as: a ProDisc-II Lumbar Disc Replacement manufactured by Synthes Spine; a FlexiCore Lumbar Disc Replacement manufactured by Stryker; a Maverick Lumbar Disc Replacement manufactured by Medtronic Sofamor Danek; a Bryan Cervical Disc Replacement manufactured by Medtronic Sofamor Danek; a Prestige ST Cervical Disc Replacement manufactured by Medtronic Sofamor Danek; a PCM Cervical Disc Replacement manufactured by Cervitech, Inc., a ProDisc-C Cervical Disc Replacement manufactured by Synthes Spine; or a Cervicore Cervical Disc Replacement manufactured by Stryker Inc. Although the above-listed implantable medical devices are generally intended for use as spinal implants, any other suitable implantable medical devices may be tested in a testing device embodying the principles of the present invention, such as: facet joint replacements, finger joint replacements, toe joint replacements, elbow replacements, shoulder replacements, knee replacements, ankle joint replacements, and temperomandibular joint replacements.

Regardless of the type of implantable medical device tested in a testing device embodying the principles of the present invention, the implantable medical device preferably includes upper and lower portions that are coupled to permit at least some level of relative movement therebetween. For example, the upper and lower portions may be coupled by a socket joint that permits the upper portion to move freely with respect to the lower portion. As another example, the upper and lower portions may be coupled by flexible connective material that permits three-dimensional movement between the portions via compression or expansion of the connective material. As yet another example, the upper and lower portions may be coupled by a pivot joint that only permits movement about a single axis.

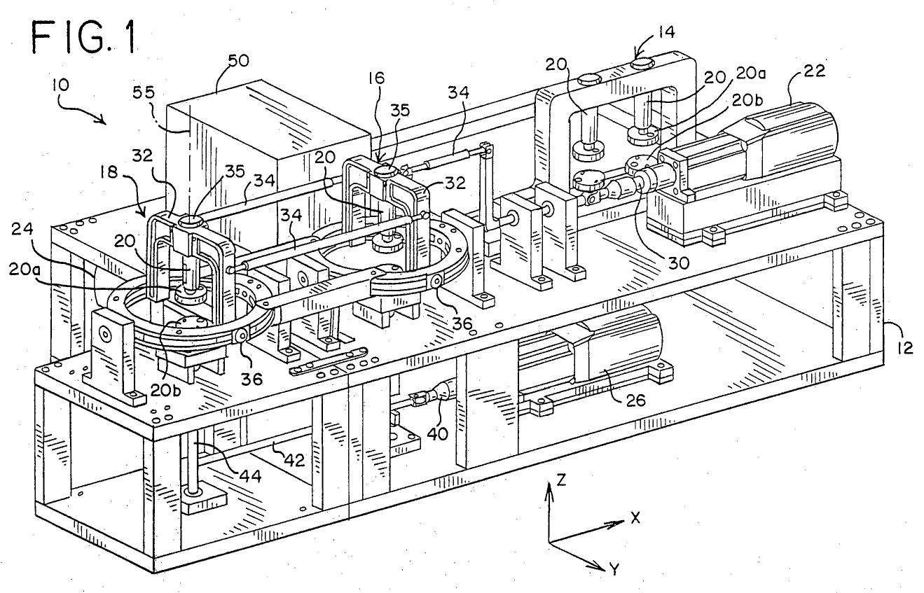

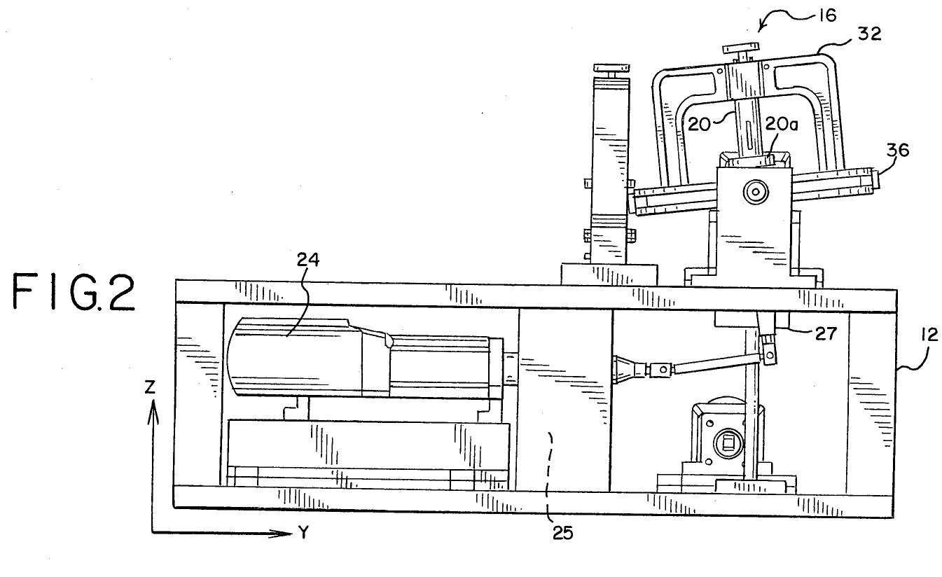

Referring now to the present invention, FIG. 1 shows a testing device 10 embodying the principles of the present invention. The testing device 10 generally includes a frame assembly 12 for supporting the components of the testing device 10; a static testing assembly 14 for testing the effects of a constant, static force acting on an implantable medical device; first and second dynamic testing assemblies 16, 18 for testing the effects of dynamic loads acting on an implantable medical device; a first actuator 22 for applying loads on the implantable medical device about the Y-axis; a second actuator 24 (best shown in FIG. 2) for applying loads on the implantable medical device about the X-axis; and a third actuator 26 for causing relative movement on the implantable medical device about the Z-axis.

The implantable medical device is positioned within one of the testing assemblies 14, 16, 18, within an axial compressor clamp 20 that includes an upper portion 20a and a lower portion 20b. The axial compressor clamps 20 each apply an axial load on the implantable medical device by adjusting the height of the lower portion 20b with respect to the upper portion 20a (or vise-versa). More specifically, once a desired axial load is applied to the implantable medical device, the upper and lower portions 20a, 20b are locked into place to simulate a constant axial load.

The first actuator 22 includes a servo motor (not shown) within the casing and an actuating rod 30 extending from the casing along the X-axis. The servo motor causes linear movement of the actuating rod 30 along the X-axis so as to control the angular position, along the Y-axis, of the upper and lower portions of the implantable medical device with respect to each other. More specifically, the actuating rod 30 is connected to a U-shaped arm 32 via connector rods 34. The U-shaped arm 32 is connected to the upper portion 20a of the compression clamp 20 and is pivotally coupled with a base ring 36 such that actuation of the actuating rod 30 causes pivoting movement of the U-shaped arm 32 with respect to the base ring 36, thereby causing pivoting movement of the upper portion 20a of the compression clamp 20 with respect to the lower portion 20b and pivoting movement of the upper portion of the implantable medical device with respect to the lower portion. This movement simulates bending movement of the implantable medical device along the Y-axis (flexion/extension movement by the implant user).

As best shown in FIG. 2, the second actuator 24 also includes a servo motor (not shown) within the casing and an actuating rod 25 extending from the casing along the Y-axis. The servo motor causes linear movement of the actuating rod 25 along the Y-axis so as to control the angular position, along the X-axis, of the upper and lower portions of the implantable medical device with respect to each other. More specifically, the actuating rod is connected to the base ring 36 via a connector rod 27 that extends through an opening in the frame 12 and connects to the base ring 36 such that movement of the actuating rod 25 causes pivoting movement of the base ring 36 about the X-axis with respect to the frame 12. The pivoting movement of the base ring 36 causes movement of the U-shaped arm 32 about the same axis (the X-axis), thereby causing pivoting movement of the upper portion 20a of the compression clamp 20 with respect to the lower portion 20b and pivoting movement of the upper portion of the implantable medical device with respect to the lower portion. This movement simulates bending movement of the implantable medical device along the X-axis (lateral bending by the implant user).

The third actuator 26 also includes a servo motor (not shown) within the casing and an actuating rod 40 extending from the casing along the X-axis. The servo motor causes linear movement of the actuating rod 40 along the X-axis so as to control the rotational position, along the Z-axis, of the upper and lower portions of the implantable medical device with respect to each other. More specifically, the actuating rod 40 is connected to the lower portion 20b of the compression clamp 20 via a connector rod 42 such that movement of the actuating rod causes rotational movement of a base rod 44 and the lower portion 20b of the compression clamp 20 about the Z-axis with respect to the frame 12. The rotational movement of the lower portion 20b of the compression clamp 20 is thereby rotated with respect to the upper portion 20a of the compression clamp 20, thereby causing rotational movement of the upper portion of the implantable medical device with respect to the lower portion. This movement simulates twisting movement of the implantable medical device about the Z-axis (axial rotation by the implant user).

The clamp 20 provides a substantially inertia-free axial load. For example, rather than using inertia-creating weights to create an axial load, the clamp 20 uses spring forces to create the axial load. The upper portion 20a of the clamp is spring-loaded with respect to the U-shaped arm 32 so that an axial load is applied by compressing the spring between a load screw 35 and the top of the disc replacement. The load screw 35 on top of the U-shaped arm 32 is used to compress the spring. The use of a spring minimizes inertial effects while containing the load within the U-shaped arm 32 allows for an axial load through all ranges of motion. Additionally a set screw is provided to eliminate load creep and a retainer screw is used to oppose rotation of the upper implant mount

In addition to the first and second dynamic testing assemblies 16, 18 additional testing assemblies may be added without the need for additional motors. For example, connector rods may be used to connect a third testing assembly to the second testing assembly 18 in a manner similar to the connector rods 34, 42 used to connect the first and second testing assemblies 16, 18.

The testing assemblies 16, 18 are preferably controlled by a controller 50. More specifically, the actuators 22, 24, 26 are controlled by the controller 50, which preferably utilizes a LabView software program. The controller 50 may be used to vary the frequency, magnitude, and direction of the movement of the implantable medical device 100.

The above-described device creates a consistent load acting on the implantable medical device, despite the bending or twisting movements acting about the X, Y, or Z axes, because the upper and lower portions 20a, 20b of the compression clamp 20 cause the various loads acting on the implantable medical device. In other words, the longitudinal axis of the upper portion 20a of the clamp engages the upper portion of the implantable device 100 at substantially the same angle regardless of the bending or twisting movements acting about the X, Y, or Z axes. Referring to FIGS. 1 and 3, the upper portion 20a defines a longitudinal compression axis 55 that remains substantially constantly normal to the top surface of the upper portion 102 of the implantable medical device 100. The upper portion 102 of the implantable medical device defines a longitudinal axis 57 and the compression axis 55 remains substantially parallel to the longitudinal axis 57 throughout testing of the implantable medical device 100. Additionally, this device offers a great deal of flexibility with respect to the type of implantable medical device being tested. For example, movement along the three axes may be tested individually or simultaneously. As another example, one or more of the actuators 22, 24, 26 may be disconnected, or one or more of the above-described joints may be locked into place, in order to limit the degrees of movement during testing.

Furthermore, the servo motors are less likely than hydraulic motors to become uncalibrated over time. Additionally, use of electric servo actuated motors eliminates the need for troublesome hydraulics and a complicated controls system. Faster testing could also be performed at the maximum allowable rate of 2 Hz. A million cycles of testing could take place in just under 6 days.

Procedures for calibrating the device 10 and programming the controller 50 are set-forth in Habeger, Jason A., Effects of Implant Offset on the Wear Characteristics of an Artificial Disc Replacement Analogue, Purdue University, West Lafayette, Ind., School of Mechanical Engineering, May, 2007.

It is therefore intended that the foregoing detailed description be regarded as illustrative rather than limiting, and that it be understood that it is the following claims, including all equivalents, that are intended to define the spirit and scope of this invention.

What is claimed is:

1. A device for fatigue testing an implantable medical device, comprising:
a compression assembly configured to support a first portion and a second portion of the implantable medical device and apply a compression force to the implantable medical device along a compression axis at a compression angle with respect to the first portion of the implantable medical device; and
a first bending assembly configured to apply a first bending force onto the implantable medical device to move the first portion of the implantable medical device about a first bending axis with respect to the second portion of the implantable medical device, wherein the first bending assembly is coupled with the compression assembly such that the compression angle remains substantially constant regardless of the position of the first portion of the implantable medical device with respect to the second portion of the implantable medical device.

2. A device as in claim 1, wherein the first portion of the implantable medical device defines a longitudinal axis and the compression axis remains substantially parallel to the longitudinal axis throughout testing of the implantable medical device.

3. A device as in claim 1, wherein the compression assembly includes a first clamp and a second clamp, and the first bending assembly includes a support bar configured to support the first clamp and to pivot about the first bending axis with respect to the second clamp.

4. A device as in claim 3, wherein the support bar is generally a U-shaped bar.

5. A device as in claim 1, wherein the compression assembly includes a first clamp and a second clamp, and the first clamp is configured to move in unison with the first portion of the implantable medical device about the first bending axis.

6. A device as in claim 5, further comprising a second bending assembly configured to apply a second bending force onto the implantable medical device to move the first portion of the implantable medical device about a second bending axis with respect to the second portion of the implantable medical device, wherein the second bending assembly is coupled with the compression assembly such that the compression angle remains substantially constant regardless of the position of the first portion of the implantable medical device with respect to the second portion of the implantable medical device.

7. A device as in claim 6, wherein the first clamp of the compression assembly is configured to move in unison with the second portion of the implantable medical device about the second bending axis.

8. A device as in claim 7, wherein the first bending assembly includes a U-shaped support bar configured to support the first clamp of the compression assembly and to pivot about the first bending axis with respect to the second clamp.

9. A device as in claim 8, wherein the second bending assembly includes a support ring configured to support the first clamp of the compression assembly and to pivot about the second bending axis with respect to the second clamp.

10. A device as in claim 9, further comprising a rotational assembly configured to apply a rotational force onto the implantable medical device to move the first portion of the implantable medical device about the compression axis with respect to the second portion of the implantable medical device.

11. A device as in claim 10, further comprising:
a first actuator configured to apply the first bending force onto the implantable medical device;
a second actuator configured to apply the second bending force onto the implantable medical device; and
a third actuator configured to apply the rotational force onto the implantable medical device.

12. A device for fatigue testing an implantable medical device, comprising:
a compression assembly configured to support a first portion and a second portion of the implantable medical device and apply a compression force to the implantable medical device along a compression axis;
a flexion assembly configured to apply a flexion force onto the implantable medical device to move the first portion of the implantable medical device about a flexion axis with respect to the second portion of the implantable medical device;
a lateral bending assembly configured to apply a lateral bending force onto the implantable medical device to move the first portion of the implantable medical device about a lateral bending axis with respect to the second portion of the implantable medical device; and
an axial rotation assembly configured to apply a rotational force onto the implantable medical device to move the first portion of the implantable medical device about the compression axis with respect to the second portion of the implantable medical device;
wherein the flexion assembly and the lateral bending assembly are coupled with each other such that the first portion of the implantable medical device is able to move simultaneously about the flexion axis and the lateral bending axis.

13. A device as in claim 12, wherein the compression assembly includes a first clamp and a second clamp, and the first clamp is configured to move in unison with the first portion of the implantable medical device about the flexion axis.

14. A device as in claim 13, wherein the first clamp of the compression assembly is configured to move in unison with the first portion of the implantable medical device about the lateral bending axis.

15. A device as in claim 14, wherein the flexion assembly includes a U-shaped support bar configured to support the first clamp of the compression assembly and to pivot about the flexion axis with respect to the second clamp.

16. A device as in claim 15, wherein the lateral bending assembly includes a support ring configured to support the first clamp of the compression assembly and to pivot about the lateral bending axis with respect to the second clamp.

17. A device for fatigue testing an implantable medical device, comprising:
a compression assembly configured to apply a compression force to the implantable medical device along a compression axis;
a flexion assembly configured to apply a flexion force onto the implantable medical device about a flexion axis;
a lateral bending assembly configured to apply a lateral bending force onto the implantable medical device about a lateral bending axis; and
an axial rotation assembly configured to apply a rotational force onto the implantable medical device about the compression axis;
wherein the flexion assembly, the lateral bending assembly, and the axial rotation assembly are coupled with each other such that they are able to apply the flexion force, the lateral bending force, and the rotational force simultaneously or individually.

18. A device as in claim 17, wherein the compression assembly includes a first clamp and a second clamp, and the first clamp is configured to move in unison with the first portion of the implantable medical device about the flexion axis.

19. A device as in claim 18, wherein the first clamp of the compression assembly is configured to move in unison with the first portion of the implantable medical device about the lateral bending axis.

20. A device as in claim 19, wherein the flexion assembly includes a U-shaped support bar configured to support the first clamp of the compression assembly and to pivot about the flexion axis with respect to the second clamp, and the lateral bending assembly includes a support ring configured to support the first clamp of the compression assembly and to pivot about the lateral bending axis with respect to the second clamp.
